(19) United States
(12) Patent Application Publication
(10) Pub. No.: US 2006/0233205 A1
(43) Pub. Date: Oct. 19, 2006

(54) Mode-matching system for tunable external cavity laser

(76) Inventors: Nestor O. Farmiga, Rochester, NY (US); Michael Joseph Litzenberger, Upper Rochester, NY (US); Mark Joseph Tronolone, Webster, NY (US)

Correspondence Address: CORNING INCORPORATED, SP-TI-3-1, CORNING, NY, 14831, US

(21) Appl. No.: 11/404,465

(22) Filed: Apr. 13, 2006

Related U.S. Application Data
(60) Provisional application No. 60/594,493, filed on Apr. 13, 2005.

(51) Int. Cl. H01S 3/098

(52) U.S. Cl. 372/18

(57) ABSTRACT

An external cavity laser includes a lasing cavity and an optically coupled feedback cavity having differently spaced resonant lasing and feedback mode frequencies. The lasing modes can be collectively or individually matched to selected feedback modes. For example, a current driving the lasing cavity can be adjusted to shift individual lasing modes into alignment with the selected feedback modes.

### FIELD OF INVENTION

Tunable external cavity lasers include a lasing cavity having resonant modes for amplifying a range of beam frequencies and a feedback cavity optically coupled to the lasing cavity and having resonant modes subject to selection for tuning the beam frequency output of the lasers.

### DESCRIPTION OF RELATED ART

Light resonates within laser cavities between front and back surfaces in distinct frequency modes at which standing waves are produced by complete round trips taken by integer numbers of wavelengths between the surfaces. The potential for gain within the laser cavities varies as a distribution function of frequency, and the optical power tends to concentrate in the frequency mode experiencing the highest gain or, conversely, the lowest loss. Beyond encounters with a lasing medium within the laser cavities, most other encounters of the light within the laser cavities entail losses, and the mode frequency experiencing the lowest loss is generally the one most amplified by the laser.

Frequency tuning of laser sources generally involves adjusting the conditions under which light is oscillated within the laser cavity to alter the nominal frequency that experiences the lowest loss. One way this is done is by coupling the output of the laser to an adjoining cavity that further participates in the oscillation of light. The external cavity includes the original cavity, which is filled with the gain medium and is referred to as “the lasing cavity”, and the adjoining cavity, which is not so filled and is referred to as “the feedback cavity”.

According to a so-called “Littrow” cavity configuration, the feedback cavity includes an adjustable output mirror or coupler in the form of a diffraction grating that diffracts one portion of the light (through a first order) on a path of retroreflection back toward the lasing cavity and reflects another portion of the light (through the zero order) in a second direction as the laser output. The lasing and feedback cavities are coupled together through a collimating lens, which collimates the light emitted through an active area on the front surface of the lasing cavity. The angle at which light is diffracted from the grating varies as a function of frequency. Of the diffracted light, only a limited band of frequencies is sufficiently aligned with the path of retroreflection to be focused by the collimating lens onto the active area of the front surface for reentry into the lasing cavity. By controlling the inclination of the diffraction grating, the frequencies capable of being retroreflected back into the lasing cavity can be adjusted.

The frequencies available for diffraction by the diffraction grating are limited to those that are amplified and emitted from the lasing cavity. The effect of returning any of the emitted frequencies to the lasing cavity is to alter the relative amounts of gain and loss experienced among the emitted frequencies. A larger effect on the loss profile is produced by returning frequencies that are also capable of oscillating in the coupled lasing and feedback cavities. Losses are further reduced by the more limited set of frequencies that satisfy a condition that they accrue a phase of exact integer multiples of 2π per round trip as they propagate between ends of the feedback cavity (i.e., between the front surface of the lasing cavity and the diffraction grating). The frequency modes of the feedback cavity are generally more closely spaced than those of the lasing cavity.

The frequency output of the external cavity lasers can be controlled, i.e., tuned, over a continuum of the range of frequencies subject to amplification within the lasing cavity or by discrete steps corresponding to combined resonant frequencies of the lasing and feedback cavities. Spectrally pure frequency outputs favoring a single output frequency depend on a matching of resonant modes within both the lasing cavity and the feedback cavity. Ideally, the frequency retroreflected by the frequency-selective element (e.g., diffraction grating) of the feedback cavity should match a resonant (mode) frequency of the feedback cavity as well as a resonant (mode) frequency of the lasing cavity. If the frequency subject to resonation within the feedback cavity does not match one of the frequencies favored for resonance within the lasing cavity, the spectral purity of the output beam is reduced. The resulting output beam can contain multiple frequencies and, thus, be less coherent. In addition, the nominal frequency of the output beam can be displaced from a natural mode frequency of the lasing cavity. Instabilities can develop if the mode frequency supported by the feedback cavity lies between two modes of the lasing cavity or even if the mode frequency of the lasing cavity lies between two modes of the feedback cavity. Either or both of the straddling mode frequencies can be amplified.

The resonant mode frequencies of feedback cavities having a fixed length tend to be evenly spaced, since most of the propagations between end surfaces take place through air, which exhibits little dispersion (i.e., frequency dependence of the refractive index). However, the resonant mode frequencies of lasing cavities also having a fixed length, such as those of laser diodes, can undergo some variation in spacing over the range of amplified frequencies, since the lasing mediums are generally dispersive. Accordingly, if the spacing between the lasing cavity modes and the feedback cavity modes are matched at one frequency, such as the peak frequency of amplification, the spacing between the lasing cavity modes and the feedback cavity modes becomes progressively less matched at higher or lower frequencies. Particularly where the nominal spacing between lasing cavity modes corresponds to an integer multiple of the feedback cavity modes, the spacing of the lasing cavity modes can vary so much as to transition through a different integer multiple of feedback cavity modes. Frequency outputs are especially unstable within the regions of transition, where mode hops and multiple lasing frequencies are observed.

Generally, single-mode semiconductor diode lasers operate at a single wavelength and, if tuned, the lasers are generally tuned over a more limited range short of any regions of transition. Temperature variations and other disturbances can shift the mode frequencies further, limiting the frequency ranges that still safely avoid the regions of transition. Heading

### SUMMARY OF INVENTION

An expanded range of frequency tuning with improved spectral purity can be achieved by the invention, which includes arrangements providing discrete tuning choices throughout a range of lasing frequencies. The invention in one or more of its preferred embodiments provides for making predetermined frequency-sensitive optical path length adjustments to match at least initially unevenly spaced resonant modes of lasing cavities to selected resonant modes of optically coupled feedback cavities. Finer adjustments can be made to more precisely align the modes of the lasing and feedback cavities or to maintain desired alignments under changing conditions.

One version of the invention as a mode-matching system for tunable external cavity lasers, includes both a lasing cavity having a set of initial lasing cavity modes favoring amplification of unevenly spaced beam frequencies and a fixed-length feedback cavity optically coupled to the lasing cavity and having a set of feedback cavity modes favoring feedback of more evenly spaced beam frequencies to the lasing cavity. A nonlinear optical path length adjuster relatively alters the frequencies of the lasing cavity modes to match selected frequencies of the feedback cavity modes.

The initial lasing cavity modes can be of the type that have a frequency spacing that varies as a function of the frequencies that are amplified within the lasing cavity. The feedback cavity modes can have a frequency spacing that remains substantially constant over a range of the frequencies that are amplified within the lasing cavity. The fixed length of the feedback cavity is preferably set so that a predetermined multiple of the substantially constant frequency spacing between feedback cavity modes at least approximately matches the frequency spacing between at least one pair of the lasing cavity modes. The nonlinear optical path length adjuster can be used at a base setting to more finely match the spacing between the at least one pair of lasing cavity modes with a predetermined multiple of the spacing between the feedback cavity modes.

The lasing cavity can include a lasing medium that exhibits a refractive index dispersion profile in which the refractive index of the lasing medium varies nonlinearly with the amplified beam frequencies. The nonlinear optical path length adjuster displaces the refractive index dispersion profile by varying amounts to move individual lasing cavity modes into alignment with the selected feedback cavity modes. For example, the nonlinear optical path length adjuster can be arranged to vary a current applied to the lasing cavity for displacing the refractive index dispersion profile of the lasing cavity.

The uneven frequency spacing of the lasing cavity modes is generally predictable, and the nonlinear optical path length adjuster can be prearranged to align the lasing cavity modes with the selected feedback cavity modes. In addition, a spectral frequency or purity monitor can be used to provide feedback to the nonlinear optical path length adjuster to more precisely or dynamically align the lasing and feedback cavity modes where the spectral purity is highest. Optical path length adjustments made in response to the spectral condition of the output beam can be used to compensate for environmental influences including temperature variations.

For purposes of selective tuning, a frequency adjuster can be used to select among the feedback cavity modes for shifting a lasing frequency output to a corresponding altered lasing cavity mode. The nonlinear optical path length adjuster is preferably responsive to the selections effected by the frequency adjuster so that shifts in lasing frequency output between the relatively altered lasing cavity modes correspond to frequency shifts between the selected feedback cavity modes.

Another version of the invention as a frequency tuning system for an external cavity laser includes a lasing cavity containing an amplifying medium for amplifying a range of frequencies and having a length favoring certain initial resonant lasing frequencies. The amplifying medium exhibits a nonlinear variation in refractive index over the range of amplified frequencies, which has the effect of unevenly spacing the initial resonant lasing frequencies. A feedback cavity, which is optically coupled to the lasing cavity, has a fixed length favoring certain initial resonant feedback frequencies having a different spacing pattern than the initial resonant lasing frequencies. A frequency selector selects among the resonant feedback frequencies for favoring amplification of correspondingly spaced resonant lasing frequencies. A nonlinear resonant frequency adjuster relatively alters the resonant lasing frequencies with respect to the resonant feedback frequencies to individually match the relatively altered resonant lasing frequencies to the selected resonant feedback frequencies.

Preferably, the initial resonant feedback frequencies of the feedback cavity are substantially evenly spaced, and the nonlinear resonant frequency adjuster alters the resonant lasing frequencies to match the selected resonant feedback frequencies. For example, the nonlinear resonant frequency adjuster can be used to alter the refractive index of the amplifying medium, such as by altering a current that is applied to the lasing cavity to produce photons by stimulated emission. In addition, alternations in the temperature of the amplifying medium or in the physical length of the lasing cavity also be used to individually match the resonant lasing frequencies to the selected resonant feedback frequencies.

Alternatively, the nonlinear resonant frequency adjuster can be arranged to alter the resonant feedback frequencies of the fixed-length feedback cavity to match the resonant lasing frequencies of the lasing cavity. For example, the nonlinear resonant frequency adjuster could be formed by an optical medium within the feedback cavity exhibiting a refractive index that varies nonlinearly over the range of amplified frequencies. The nonlinear variation in the refractive index of the optical medium within the feedback cavity can be arranged to correspond to the nonlinear variation in refractive index of the amplifying medium within the lasing cavity over the range of amplified frequencies.

The output frequencies of the laser can vary in spectral purity as a function of the relative alignment between the resonant lasing frequencies and the selected resonant feedback frequencies and a spectral purity monitor is used to monitor these variations. The nonlinear resonant frequency adjuster can be made responsive to a measure of the spectral purity of the output frequencies for performing the desired alignments.

Another version of the invention as a method of mode matching between a lasing cavity and a feedback cavity within an external cavity laser, includes optically coupling a feedback cavity having resonant feedback modes that are substantially evenly spaced to a lasing cavity having resonant lasing modes that are unevenly spaced over a range of frequencies amplified within the lasing cavity. The optical path length of the feedback cavity is set to relate an integer multiple of the spacing between feedback cavity modes to the spacing between one or more pairs of lasing cavity modes within the lasing cavity. Selections are made among the feedback cavity modes for coupling to the lasing cavity; and relative adjustments are made to the other lasing cavity modes to match the selected feedback cavity modes.

Preferably, the relative adjustments include making individual adjustments to the lasing cavity modes in association with the feedback cavity modes coupled to the lasing cavity. For example, current to the lasing cavity can be adjusted in association with the selection among feedback frequencies for changing a refractive index of an optical medium within the lasing cavity.

The optical path length of the feedback cavity is preferably set to relate the integer multiple of the spacing between feedback cavity modes to the spacing between the one or more pairs of lasing cavity modes located near a center of the range of frequencies amplified within the lasing cavity. The adjustments to the uneven spacing between the lasing cavity modes include making progressively larger adjustments for lasing cavity modes that increasingly depart from the center of the range of frequencies amplified by the lasing cavity.

In addition, the spectral purity of output lasing frequencies can be monitored as a feedback for further adjusting or maintaining individual lasing modes in alignment with the selected feedback modes. The further adjustments can compensate for environmental influences to maintain or enhance the spectral purity of the output beam.

The invention is particularly useful as a tunable light source for frequency shifting interferometers, which make distance measurements including measurements of surface height variations by determining a rate at which individual points cycle through conditions of constructive and destructive interference with changes in illuminating beam frequency. The rate increases with distance. Accuracy can be increased by incrementally varying beam frequency over a larger range. Accordingly, expanded tuning ranges are particularly beneficial to frequency shifting interferometers. Measures of contrast or phase can also be used as feedback for measuring spectral purity and frequency drift.

### BRIEF DESCRIPTION OF THE DRAWINGS

FIG. 1 is a diagram of an external cavity laser in accordance with the invention having fixed length lasing and feedback cavities.

FIG. 2 is a diagram showing optical path lengths of the lasing and feedback cavities of a laser with matching modes within both cavities.

FIG. 3 is a plot illustrating a refractive index dispersion profile of the lasing cavity.

FIG. 4 is a plot of gain over a domain of frequency for a lasing cavity schematically showing the available frequency modes under a curve of potential gain.

FIG. 5 is a diagram showing a progressive mismatch of lasing cavity modes to feedback cavity modes from a center position of alignment.

FIG. 6 is a diagram showing a control system for selecting among the feedback cavity modes and for matching the lasing cavity modes to the selected feedback cavity modes.

FIG. 7 plots the effects of current manipulations on the laser frequency response over three different domains of the frequency response.

### DETAILED DESCRIPTION OF THE INVENTION

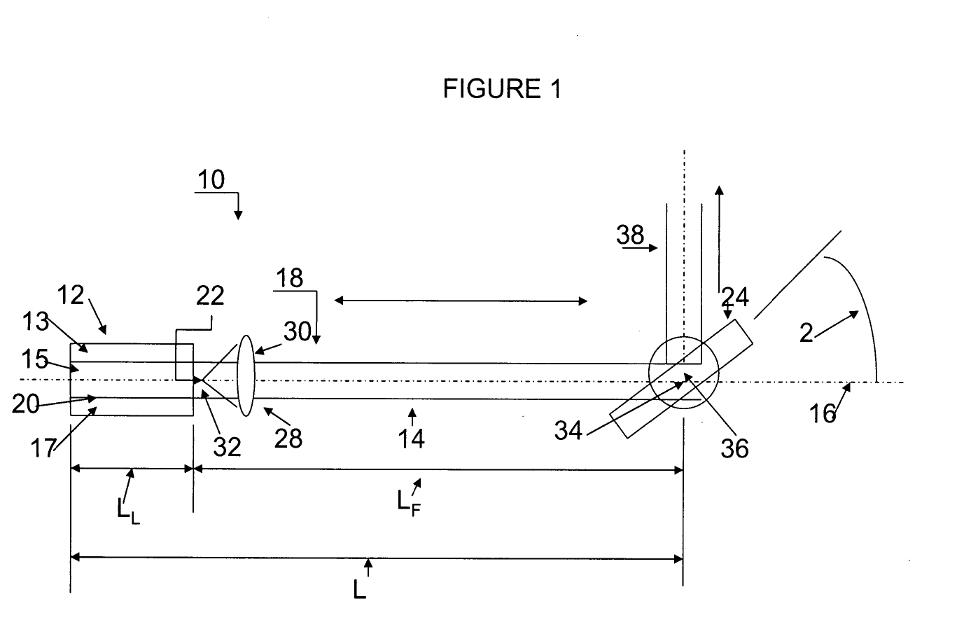

As shown in FIG. 1 a laser 10, which is preferably a semiconductor diode laser, includes a lasing cavity 12 and an adjoining feedback cavity 14 aligned along a common optical axis 16. Together, the cavities 12 and 14 form an external cavity 18.

The lasing cavity 12 contains a lasing medium (an active layer) 15 sandwiched between two electrically biased regions 13 and 17 (e.g., p and n regions) and has a fixed length L_{L} along the optical axis 16 between a reflective back surface 20 and a reflective front surface 22 located at opposite ends of the lasing cavity 12. The gain is such for conventional laser diodes that the front surface 22 requires only a small reflectivity (e.g., approximately 4 percent) to support resonant frequency modes. The feedback cavity 14, which is filled with air, has a fixed length L_{F} between the front surface 22 of the lasing cavity 12 and a pivotable reflective surface 24 located at an opposite end of the feedback cavity 14. A collimating lens 28 forms an optical coupling 30 between the lasing and feedback cavities 12 and 14 through an active area 32 of the front surface 22. Combined, the lasing cavity 12 and the feedback cavity 14 form an external cavity having a fixed overall length L.

The pivotable surface 24 includes a diffraction grating 34 that diffracts one order, preferably the first order, back toward the lasing cavity 12 and that diffracts another order, preferably the zero order, beyond the feedback cavity 14 as the laser output beam 38. Within the preferred first order of diffraction, the diffraction grating 34 angularly disperses incident light according to its frequency, such that a single frequency of light is retroreflected back along the optical axis 16 to the optical coupling 30. However, the diffraction grating 34 is pivotable as a part of the surface 24 about a pivot axis 36 through a pivot angle α so that a range of different frequencies can be retroreflected along the optical axis 16. A folding mirror (not shown) moves together with the diffraction grating 34 to maintain a single output direction for the laser output. Such folding mirrors are shown in U.S. Pat. No. 6,690,690, entitled TUNABLE LASER SYSTEM HAVING AN ADJUSTABLE EXTERNAL CAVITY, which is hereby incorporated by reference.

Although other frequencies are reflected in the general direction of the optical coupler 30, only light that is substantially collimated along the optical axis 16 is coupled to the lasing cavity 12 through the limited active area 32. Neighboring frequencies that are angularly dispersed by the diffraction grating 34 from the optical axis 16 converge elsewhere, not upon the limited active area 32 of the optical coupler 30. The resolution of the diffraction grating 34 is preferably large enough to feedback each frequency within the tunable range of the laser 10 by positioning the grating 34 at a unique angle α for each frequency.

The pivot axis 36, which extends through a reflective face of the diffraction grating 34, intersects the optical axis 16 so that angular movement of the diffraction grating 34 about the pivot axis 36 does not change the length L_{F} of the feedback cavity 14. Thus, the diffraction grating 34 can be pivoted through a range of angles α for controlling the frequency of light that is retroreflected along the optical axis 16 within the feedback cavity 14. The optical coupler 30 limits the coupling of light from the feedback cavity 14 to the lasing cavity 12 to retroreflections along the optical axis 16. Together, the pivotable diffraction grating 34 and the optical coupling 30 control the frequencies that can be returned to the lasing cavity 12.

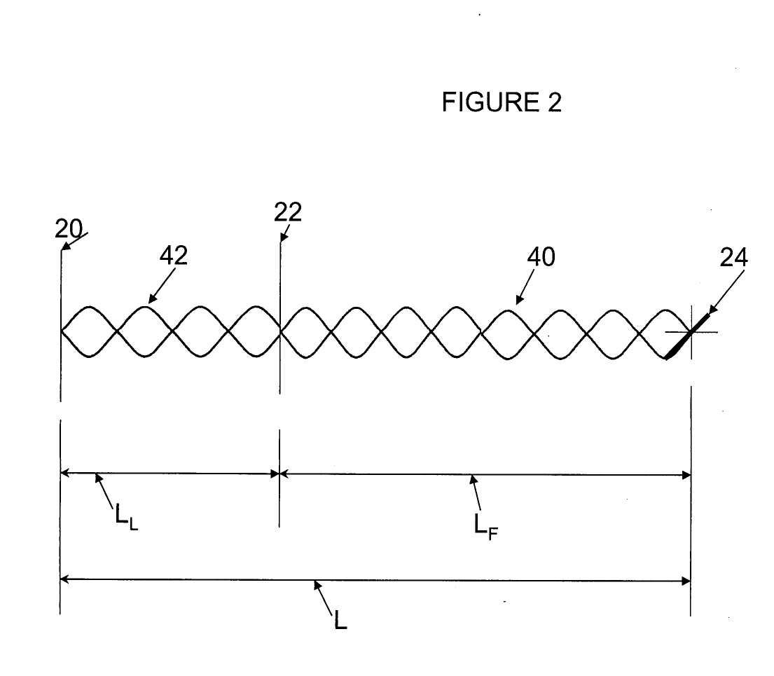

The fixed length L_{F} of the feedback cavity 14 as shown in FIG. 2 supports the resonance of certain among the tunable frequencies as standing waves 40. The resonant frequencies or modes of the feedback cavity 14 correspond to frequencies whose wavelengths evenly divide the round-trip optical path length of the feedback cavity 14. Since most of the feedback cavity 14 is filled with air as the propagating medium, the optical path length is close to the physical path length L_{F} of the feedback cavity 14 and is relatively insensitive to changes in beam frequency. Accordingly, twice the optical path length equals an integer multiple N2 of the wavelengths of the resonant frequencies or modes of the feedback cavity 14. The propagation of other frequencies within the feedback cavity 14 is suppressed by interference. Thus, among the frequencies diffracted back by the angular position of the diffraction grating 34, the resonant frequencies or modes of the feedback cavity 14 propagate at the highest amplitudes.

The frequency spacing Δν₂ between modes of the feedback cavity 14 is given as follows.
Δν_{F}=c/2n_{F}L_{F}
where c is the speed of light, n_{F} is the average refractive index of the feedback cavity (nearly 1), and L_{F} is the physical length of the feedback cavity 14. Since both the nominal refractive index n_{F} of the air and the cavity length L_{F} remain substantially constant over the range of beam frequencies, the frequency spacing Δν_{F} also remains substantially the same over the range of beam frequencies. For example, a feedback mode spacing Δν_{F} of 10 GHz arises from a feedback cavity length L_{F} of approximately 15 millimeters assuming a refractive index n_{F} close to 1.0.

The fixed length L_{L} of the lasing cavity 12 supports resonance among certain frequencies ν that are subject to amplification by the lasing medium 15 as standing waves 42. The resonant frequencies or modes of the lasing cavity 12 correspond to frequencies ν whose wavelengths evenly divide the round-trip optical path length of the lasing cavity 12. However, the lasing medium 15 has a refractive index n_{L} that is subject to a nonlinear variation with beam frequency ν.

The frequency spacing Δν_{L} between modes of the lasing cavity 12 is given as follows.
Δν_{L}=c/2n_{L}L_{L}

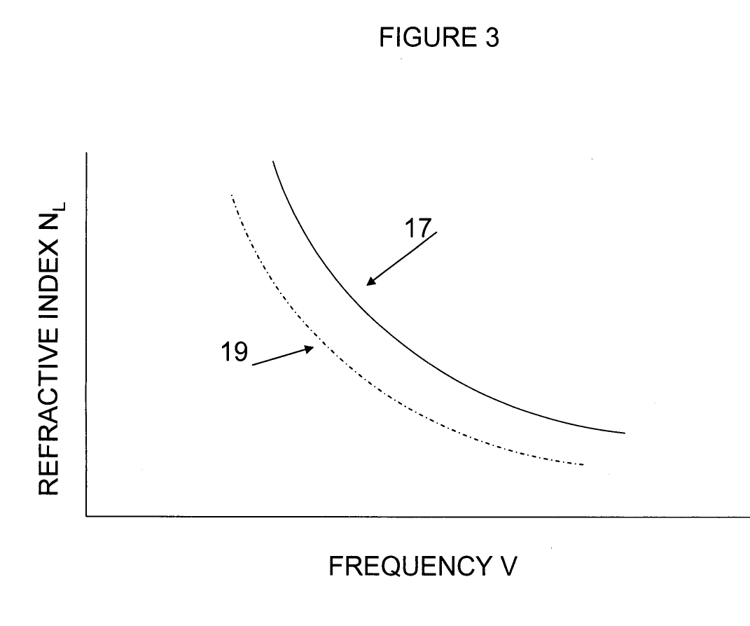

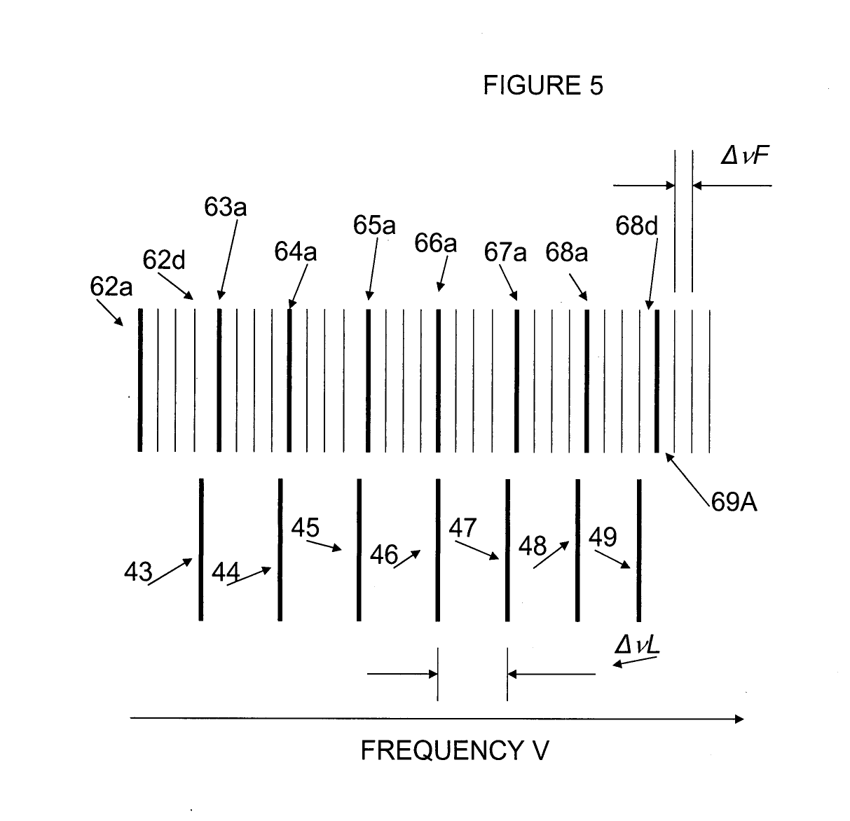

The refractive index n_{L} of the lasing cavity 12 is subject to a nonlinear variation with beam frequency vas follows:
n_{L}=f(ν)
where f(ν) is a nonlinear function of ν. A graph in FIG. 3 plots a typical nonlinear refractive index variation 17 over the range of frequencies amplified by the lasing cavity 12. The result is an uneven spacing between the modes of the lasing cavity 12, which is emphasized by FIG. 5. For a lasing medium 15 having a nominal refractive index of approximately 3.5, a nominal lasing mode spacing Δν_{L} of 50 GHz arises from a cavity length L_{L} of approximately 1 millimeters. Overall, the external cavity of the exemplary laser 10 can have a length L of approximately 16 millimeters.

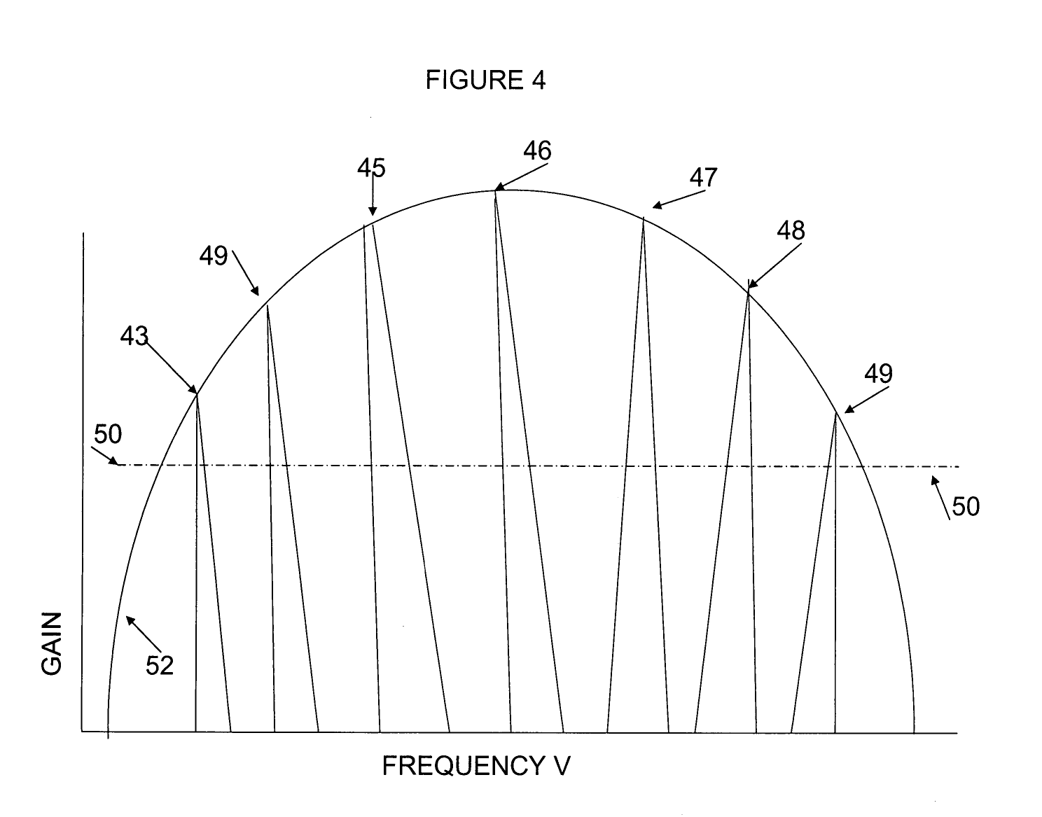

FIG. 4 plots resonant frequencies or modes 43, 44, 45, 46, 47, 48, and 49 with gains the exceed a lasing threshold 50 for gain from the lasing medium 15 in the lasing cavity 12. The modes 43, 44, 45, 46, 47, 48, and 49 vary in amplitude according to their potential for amplification within the lasing cavity 12 (as bounded by the envelope 52) and also vary slightly in spacing as a result of the frequency-sensitive refractive index variation f(ν) of the lasing medium 15. The result of the latter is a misalignment between the evenly spaced modes of the feedback cavity 14 and the unevenly spaced modes of the lasing cavity 12.

Although only seven lasing modes 43, 44, 45, 46, 47, 48, and 49 are depicted in the views of FIGS. 4 and 5, many more lasing modes are generally available for purposes of tuning. For example a semiconductor laser diode available from Mitsubishi Electric as a ML6XX34 series laser having a nominal wavelength of 785 nm is capable of amplifying lasing modes nominally spaced at approximately 50 GHz over a bandwidth of approximately 5000 GHz. A total of around 100 different lasing modes are available as discretely tunable frequencies. However, the exact spacing between lasing modes varies over the bandwidth.

FIG. 5 compares the sample lasing modes 43 through 49 of the lasing cavity 12 with evenly spaced the feedback modes 62a-d, 63a-d, 64a-d, 65a-d, 66a-d, 67a-d, 68a-d and 69a-d of the feedback cavity 14 over the range of frequencies subject to amplification. The feedback modes 62a through 69d of the feedback cavity 14 are substantially evenly spaced at a constant spacing Δν_{F} over the considered range of frequencies. The individual lasing modes 43 through 49 of the lasing cavity 12 vary in spacing Δν_{L}, and tend to decrease as a function of increasing frequency ν. The feedback mode frequencies 63a, 64a, 65a, 66a, 67a, 68a, 69a, which are emphasized by slightly increased line width correspond to the selected feedback frequencies for optical coupling with the lasing cavity 12. Near the median frequency ν₀, the lasing mode pairs 45 & 46 and 46 & 47 of the lasing cavity 12 are spaced by an amount approximately equal to an integer multiple of four times the constant spacing Δν_{F} between the feedback modes 60a through 69d and are directly aligned with the selected feedback modes 65a & 66a and 66a & 67a. Approaching the ends of the illustrated frequency range, the lasing mode pair 43 & 44 is spaced by a larger amount and the lasing mode pair 48 & 49 is spaced by a smaller amount. As a result of the spacing variation, the lasing modes 44 and 48 have drifted out of alignment with the selected feedback modes 64a and 68a. In fact, the lasing modes 43 and 49 have drifted so far out of alignment with the selected feedback modes 63a and 69a that they have aligned with alternative feedback modes 62d and 68d. Frequency instability and reduced spectral purity can result from such misalignments between selected feedback modes and the nearest lasing modes, especially where the misalignments approach alternative feedback modes.

The invention as preferably embodied deals with such misalignments, such as by altering the frequencies of the lasing modes that depart from the selected frequencies of the feedback modes, e.g., 63a, 64a, 65a, 66a, 67a, 68a, and 69a. Generally, the feedback cavity 14 is expected to be longer than the lasing cavity 12, so that the mode spacing Δν_{F} of the feedback cavity 14 is finer than the mode spacing Δν_{L} of the lasing cavity 12. The length L_{F} of the feedback cavity 14 is preferably set so that an integer multiple of the feedback mode spacing Δν_{F} is equal to a nominal spacing Δν_{L} of the lasing cavity modes, which can be considered as an average spacing or a spacing located at the center or elsewhere of the amplified frequencies. FIG. 5 shows a preferred alignment of the selected feedback cavity modes 65a, 66a, 67a with the lasing modes 45, 46, and 47 about the center (median) frequency ν₀.

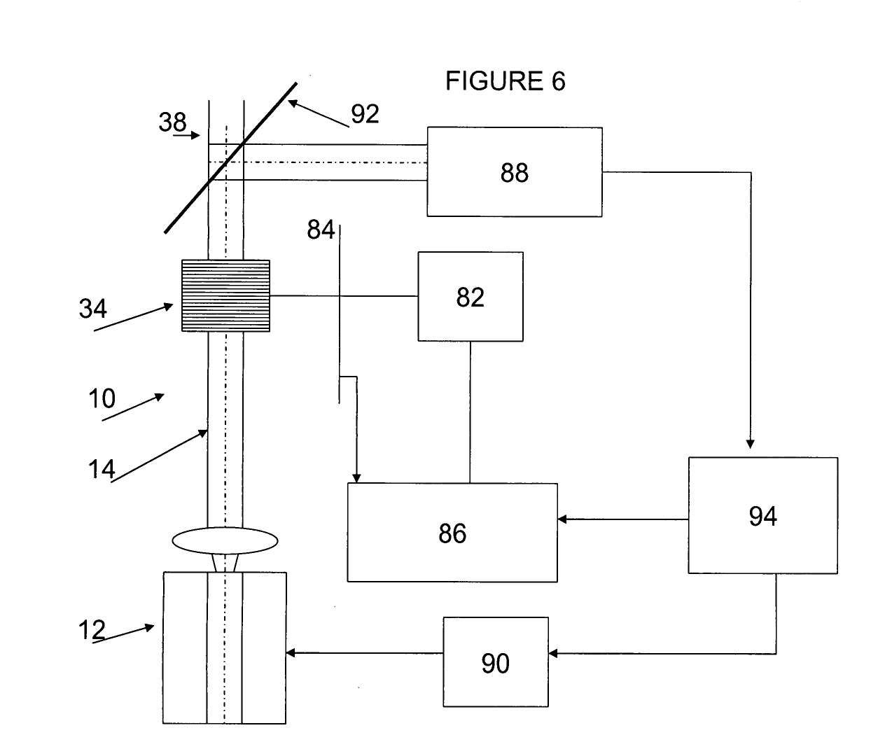

A laser control system depicted in FIG. 6 provides for tuning the output 38 of the external cavity laser 10 through discrete steps that correspond to overlapping modes of the lasing and feedback cavities 12 and 14. A motor (or voice coil) 82 pivots the diffraction grating 34, and conventional feedback system 84 (e.g., a rotary encoder) is used in conjunction with a motor driver 86 for monitoring and controlling the rotational position of the motor 82 to effect the desired inclination of the diffraction grating 34 through angle α (see FIG. 1). Variations are made to the angle α to select a desired feedback frequency for choosing among the available lasing modes of the lasing cavity 12. The changes in angle α are accompanied by a nonlinear optical path length adjustment of the lasing cavity 12 so that the feedback mode linked to the angle α is aligned with a desired lasing mode.

The lasing cavity 12 is supplied with current from a laser diode driver 90 for inducing the stimulated emission of photons within the lasing cavity 12. One example of such drivers ia available from Thorlabs, Inc. of Newton, N.J. as laser diode driver number LD1255. An external control feature of the laser diode driver 90 accepts a control voltage to adjust the current supplied to the lasing cavity 12. Variations in the current supplied to the lasing cavity 12 tend to displace the refractive index dispersion profile such as shown by phantom line 19 in FIG. 3. The current can be varied by voltage regulation, so that the refractive index profile of the lasing medium 15 remains constant or varies linearly with changes in the beam frequency propagating through the medium 15. A different amount of current can be supplied for each different beam frequency intended for amplification by the lasing cavity so that the lasing modes are individually matched to the selected feedback modes.

If selected feedback modes separated by an integer multiple number of feedback modes are matched at a particular current value (e.g. a base current) to similarly spaced lasing modes, such as lasing mode parings near the median of the amplified frequencies, the remaining lasing modes can be matched to other similarly spaced feedback modes by adjusting the current applied to the lasing cavity 12. The amount of current correction can be expected to increase as the lasing modes depart from the frequency (e.g., the median frequency) at which they are initially matched to the selected feedback modes.

Thus, the amount of current change depends upon the frequency departure from the initially matched frequency and on the amount of nonlinear variation in the refractive index associated with the frequency departure. With different currents associated with different lasing frequencies, the effective mode spacing of the lasing cavity 12 can be matched to a multiple of the mode spacing of the feed back cavity 14.

Alternatively, the feedback mode frequencies selected for optical coupling to the lasing cavity 12 can be irregularly spaced such as at different multiples of the feedback mode spacing Δν_{F}. Variations in the spacing between the selected feedback modes can be accommodated by altering the effective optical path length of the lasing cavity 12, such as by the above-described current-induced variation in refractive index, so that a lasing mode is matched to each of the irregularly spaced selected feedback modes. Thus, instead of matching unevenly spaced lasing modes to evenly spaced selected feedback modes, the lasing modes, whether evenly or unevenly spaced, can also be matched to unevenly spaced selected feedback modes. The uneven spacing between the selected feedback modes can be as a result of an uneven mode spacing Δν_{F} or as a result of an unequal number of even mode spacings between the selected feedback modes.

The uneven spacing between lasing modes that result from refractive index variations with lasing frequency, i.e., the refractive index dispersion profile, can be predetermined along with the variations in current required to match the lasing modes to selected feedback modes. However, laser performance as measured by the spectral purity of the output beam 38 can be measured to provide feedback for more finely adjusting the lasing modes to match the selected feedback modes or to compensate for dynamic factors such as environmental influences or system instabilities that can shift or distort the mode positions of either the lasing cavity or the feedback cavity.

The laser control system depicted in FIG. 6 includes optical feedback system 88 including a monitor, such as a frequency analyzer, that can be used for monitoring a portion of the output beam 38 diverted by a beamsplitter 92. An example of such a feedback system is disclosed in co-assigned U.S. application Ser. No. 10/946,691 entitled OPTICAL FEEDBACK FROM MODE-SELECTIVE TUNER, which is hereby incorporated by reference. For example, contrast between interference fringes produced within the feedback system 88 can be used to monitor the spectral purity of the output beam 38. High contrast is evidence of good spectral coherence and close alignments between the lasing and feedback modes. Low contrast is evidence of poor spectral coherence and misalignments between the lasing and feedback modes. Measures of spectral purity and frequency drift by the feedback system 88 can also be used to make other adjustments including adjustments to the angle α at which the grating 34 is inclined for controlling the feedback frequency. A controller 94 gathers the optical information from the feedback system 88 for controlling both the motor driver 86 and the laser diode driver 90.

A change in the base current at which a first pairing of lasing and feed back modes are initially matched tends to shift the frequencies of the lasing modes with respect to the frequencies of the feedback modes similar to a change in the physical length L_{L} of the lasing cavity 12. Although also accompanied by a small change in the nominal mode spacing Δν_{L} of the lasing cavity 12, the frequency shifts are much more pronounced because they reflect the cumulative effect of the mode spacing change over a number of resonating cycles. This allows the length L_{F} of the feedback cavity to be set for matching a nominal spacing Δν_{L} of the lasing modes and the nominal refractive index n_{L} of the lasing medium 15 to be set for more precisely aligning corresponding lasing and feedback modes on center or elsewhere within their range of overlap. The individual adjustments to current can be made to align the remaining lasing modes to the selected feedback modes.

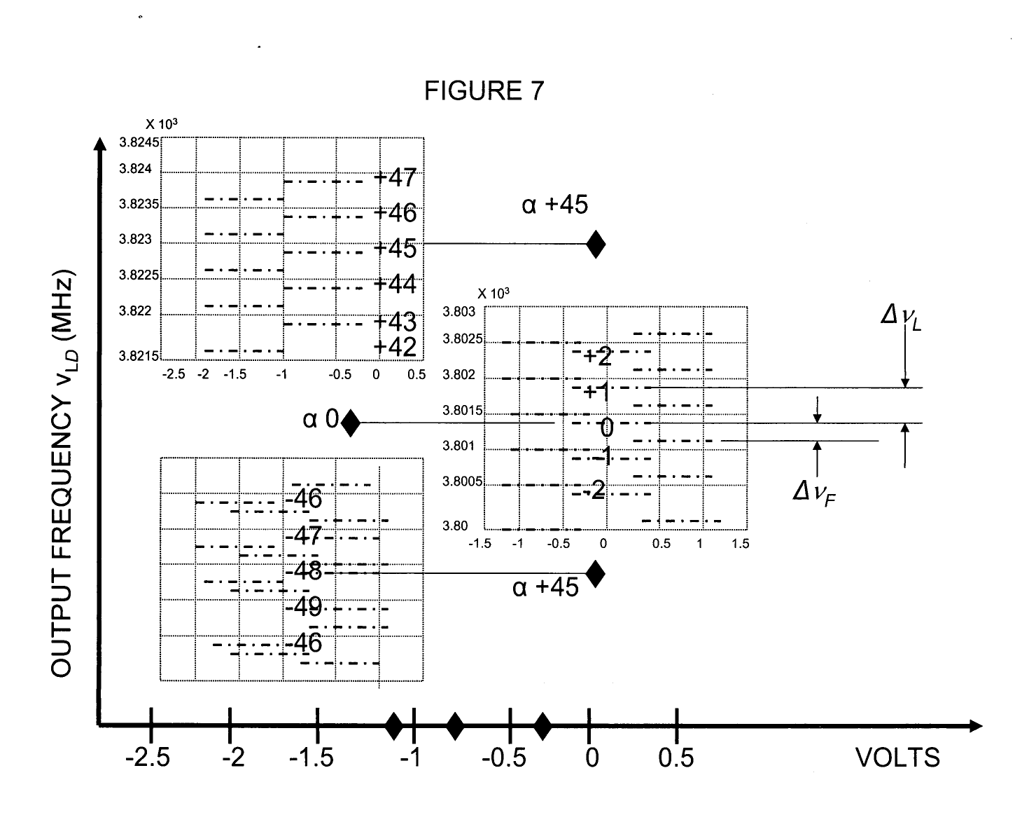

FIG. 7 shows in detail frequency effects of current variations, referenced in terms of control voltages at three different sections of the lasing cavity bandwidth. In the middle section of the bandwidth corresponding to lasing modes +2 through −2, the change in optical path length caused by the small variations of current does not effect significant changes in mode frequency until the optical path length difference is sufficient enough to align the lasing cavity modes with a different one of the feedback cavity modes. The desired alignment within the center section of the bandwidth, such as at the diffraction grating setting α₀, is achieved at an input control signal to the laser diode driver 90 of −0.3 V corresponding to a laser diode current input of 80.2 mA. At one end of the lasing cavity bandwidth corresponding to lasing modes +42 through +47, a control signal of −0.7 V (79.4 mA) is required to achieve the desired alignment at the diffraction grating setting α₊₄₅. At slightly less negative voltages (i.e., approaching 0.0 V), the output frequency enters a region of uncertainty, and at slightly more negative voltages (i.e., approximately −1.1 V), the output frequency hops by an amount of the feedback mode spacing Δν_{F} after passing through a region of uncertainty. At the other end of the lasing cavity bandwidth corresponding to modes −46 through −50, a control voltage of approximately −1.1 V (78.5 mA) is required to achieve the desired alignment at the diffraction grating setting α−₄₈. At slightly less negative voltages (i.e., approximately −0.4 V), the output frequency hops down by the amount of the feedback mode spacing Δν_{F}, and at slightly more negative voltages (i.e., approximately −1.4 V), the output frequency hops up by an amount of the feedback mode spacing Δν_{F} after passing through regions of uncertainty. Thus both ends of the bandwidth require current adjustments associated with negative voltages for evenly spacing the modes throughout the lasing cavity bandwidth. The resulting current variation to the lasing cavity is within the range of 2 mA.

Although changes to the optical path length of the lasing cavity 12, such as by varying the refractive index n_{L} of its lasing medium 15, are preferably used for matching the lasing modes to selected feedback modes, changes can also be made to the optical path length of the feedback cavity to effect a similar matching. For example, one or more transmissive mediums, including the optical coupling 30, can be arranged by choice of material with a refractive index dispersion profile that effectively matches the refractive index dispersion profile of the lasing medium 15. Even a partial matching of refractive index dispersion profiles could be used to reduce demands for individually matching the lasing modes to the selected feedback modes.

The invention is particularly applicable to frequency-shifting interferometry in which distances, particularly surface height variations, are measured by producing a series of interference patterns at different measuring beam frequencies. The laser 10 supports the tuning of discrete beam frequencies corresponding to the mode spacing or a multiple of the mode spacing of the lasing cavity. Frequency monitoring is simplified by limiting the measuring beam frequencies to certain frequency steps that can be monitored more easily than changes in beam frequencies over a continuum.

Although the invention has been described with respect to particular embodiments, those of skill in the art will appreciate that a wide range of variations can be made in the components, configurations, and tuning methods within the overall teaching of the invention. For example, the invention can be practiced with other types of lasers, including gas, dye, and solid-state lasers.

What is claimed is:

1. A mode-matching system for tunable external cavity lasers, comprising:
a lasing cavity having a set of initial lasing cavity modes favoring amplification of unevenly spaced beam frequencies;
a fixed length feedback cavity optically coupled to the lasing cavity and having a set of feedback cavity modes favoring feedback of more evenly spaced beam frequencies to the lasing cavity; and
a nonlinear optical path length adjuster that relatively alters the frequencies of the lasing cavity modes to match selected frequencies of the feedback cavity modes.

2. The system of claim 1 in which the initial lasing cavity modes have a frequency spacing that varies as a function of the frequencies that are amplified within the lasing cavity.

3. The system of claim 2 in which the feedback cavity modes have a frequency spacing that remains substantially constant over a range of the frequencies that are amplified within the lasing cavity.

4. The system of claim 3 in which the fixed length of the feedback cavity is set so that a predetermined multiple of the substantially constant frequency spacing between the feedback cavity modes substantially matches the frequency spacing between at least one pair of the lasing cavity modes.

5. The system of claim 4 in which the nonlinear optical path length adjuster includes a base setting to more finely match the spacing between the at least one pair of lasing cavity modes with a predetermined multiple of the spacing between the feedback cavity modes.

6. The system of claim 1 in which the lasing cavity includes a lasing medium that exhibits a refractive index dispersion profile in which the refractive index of the lasing medium varies nonlinearly with the amplified beam frequencies.

7. The system of claim 5 in which the nonlinear optical path length adjuster displaces the refractive index dispersion profile by varying amounts to move individual lasing cavity modes into alignment with the selected feedback cavity modes.

8. The system of claim 6 in which the nonlinear optical path length adjuster varies a current applied to the lasing cavity for displacing the refractive index dispersion profile of the lasing cavity.

9. The system of claim 6 in which the nonlinear optical path length adjuster varies a temperature of the lasing medium for displacing the refractive index dispersion profile of the lasing cavity.

10. The system of claim 1 further comprising a monitor providing feedback to operate the nonlinear optical path length adjuster for more closely aligning the altered lasing cavity modes with the selected feedback cavity modes.

11. The system of claim 10 in which a lasing frequency output varies in spectral purity as a function of the relative alignment between the altered lasing cavity modes and the selected feedback cavity modes, and the monitor measures the spectral purity of the lasing frequency output.

12. The system of claim 10 in which the monitor measures interference fringe contrast.

13. The system of claim 10 in which a lasing frequency output varies with respect to a desired frequency output, and the monitor measures frequency changes in the lasing frequency output.

14. The system of claim 13 in which the monitor measures interference phase shifts.

15. The system of claim 1 further comprising a frequency adjuster that selects among the feedback cavity modes for shifting a lasing frequency output to a corresponding relatively altered lasing cavity mode.

16. The system of claim 15 in which the nonlinear optical path length adjuster is responsive to the selections effected by the frequency adjuster so that shifts in lasing frequency output between the relatively altered lasing cavity modes correspond to frequency shifts between the selected feedback cavity modes.

17. A frequency tuning system for an external cavity laser, comprising:
a lasing cavity containing an amplifying medium for amplifying a range of frequencies and having a lasing cavity length favoring certain initial resonant lasing frequencies;
the amplifying medium exhibiting a nonlinear variation in refractive index over the range of amplified frequencies and having an effect of unevenly spacing the initial resonant lasing frequencies;
a feedback cavity optically coupled to the lasing cavity and having a fixed feedback cavity length favoring certain initial resonant feedback frequencies having a different spacing pattern than the initial resonant lasing frequencies;
a frequency selector that selects among the resonant feedback frequencies for favoring amplification of corresponding resonant lasing frequencies; and
a nonlinear resonant frequency adjuster that relatively alters the resonant lasing frequencies with respect to the resonant feedback frequencies to individually match the relatively altered resonant lasing frequencies to selected resonant feedback frequencies.

18. The system of claim 17 in which the initial resonant feedback frequencies of the feedback cavity are substantially evenly spaced, and the nonlinear resonant frequency adjuster individually alters the resonant lasing frequencies to match selected resonant feedback frequencies.

19. The system of claim 18 in which the nonlinear resonant frequency adjuster alters the refractive index of the amplifying medium.

20. The system of claim 19 in which the nonlinear resonant frequency adjuster alters a current that is applied to the lasing cavity for altering the refractive index of the amplifying medium.

21. The system of claim 19 in which the nonlinear resonant frequency adjuster alters a temperature of the amplifying medium for altering the refractive index of the amplifying medium.

22. The system of claim 17 in which the nonlinear resonant frequency adjuster alters the lasing cavity length for altering an optical path length of the lasing cavity.

23. The system of claim 17 in which the nonlinear resonant frequency adjuster alters the resonant feedback frequencies of the feedback cavity to match the unevenly spaced resonant lasing frequencies of the lasing cavity.

24. The system of claim 23 in which the nonlinear resonant frequency adjuster is formed by an optical medium within the feedback cavity exhibiting a refractive index that varies nonlinearly over the range of amplified frequencies.

25. The system of claim 24 in which the nonlinear variation in the refractive index of the optical medium within the feedback cavity corresponds to the nonlinear variation in refractive index of the amplifying medium within the lasing cavity over the range of amplified frequencies.

26. The system of claim 17 in which the resonant lasing frequencies vary in spectral purity as a function of the relative alignment between the resonant lasing frequencies and the selected resonant feedback frequencies.

27. The system of claim 26 further comprising a monitor for monitoring the variations in spectral purity.

28. The system of claim 26 in which the nonlinear resonant frequency adjuster is responsive to a measure of the spectral purity of the resonant lasing frequencies.

29. The system of claim 17 in which the resonant lasing frequencies vary in frequency output with respect to the selected resonant feedback frequencies.

30. The system of claim 29 further comprising a monitor for monitoring the frequency variations.

31. The system of claim 30 in which the nonlinear resonant frequency adjuster is responsive to a measure of the frequency variations of the resonant lasing frequencies.

32. A method of mode matching between a lasing cavity and a feedback cavity of an external cavity laser, comprising steps of:
optically coupling a feedback cavity having resonant feedback modes that are substantially evenly spaced to a lasing cavity having resonant lasing modes that are unevenly spaced over a range of frequencies amplified within the lasing cavity;
setting an optical path length of the feedback cavity to relate an integer multiple of the spacing between feedback cavity modes to the spacing between one or more pairs of lasing cavity modes within the lasing cavity;
selecting among the feedback cavity modes for amplification; and
relatively adjusting other of the lasing cavity modes to match the selected feedback cavity modes.

33. The method of claim 32 including a step of selecting among the resonant feedback modes for optical coupling to the laser cavity, and in which the step of relatively adjusting includes making individual adjustments to the lasing modes in association with the feedback modes that are selected for coupling to the lasing cavity.

34. The method of claim 33 in which the step of relatively adjusting includes adjusting current to the lasing cavity for changing a refractive index of an optical medium within the lasing cavity.

35. The method of claim 33 in which the step of relatively adjusting includes adjusting a temperature of the lasing cavity for changing a refractive index of an optical medium within the lasing cavity.

36. The method of claim 32 in which the step of setting the optical path length of the feedback cavity includes at least approximately matching the integer multiple of the spacing between feedback cavity modes to the spacing between the one or more pairs of lasing cavity modes.

37. The method of claim 36 in which the step of relatively adjusting the lasing cavity modes includes making progressively larger adjustments for lasing cavity modes that increasingly depart from the one or more pairs of lasing modes that are approximately matched to the integer multiple of the spacing between feedback modes.

38. The method of claim 36 including a step of relatively adjusting the approximately matched lasing modes to more closely match the feedback modes to which the lasing modes are approximately matched.

39. The method of claim 38 in which the step of relatively adjusting the approximately matched lasing modes includes adjusting a refractive index of the lasing cavity.

40. The method of claim 39 in which the step of relatively adjusting the approximately matched lasing modes includes adjusting current to the lasing cavity.

41. The method of claim 32 including a further step of monitoring output lasing frequencies as feedback for carrying out the step of relatively adjusting the resonant lasing modes.

42. The method of claim 41 in which the step of relatively adjusting the lasing cavity modes is responsive to measures of the output lasing frequencies to better align the lasing modes with selected ones of the feedback cavity modes.

43. The method of claim 42 in which the step of monitoring includes monitoring a spectral purity of the output lasing frequencies, and the step of relatively adjusting includes relatively adjusting the lasing cavity modes responsive to measures of the spectral purity of the output lasing frequencies.

44. The method of claim 32 in which the step of setting the optical path length of the feedback cavity to relate an integer multiple of the spacing between feedback cavity modes to the spacing between one or more pairs of lasing cavity modes within the lasing cavity includes adjusting a refractive index of the lasing cavity.

45. The method of claim 44 in which current to the lasing cavity is controlled for adjusting the refractive index of the lasing cavity.

46. The method of claim 32 in which the step of relatively adjusting other of the lasing cavity modes to match the selected feedback cavity modes includes making further relative adjustments to compensate for changes to operating conditions affecting an optical path length of at least one of the lasing and feedback cavities.

47. The method of claim 46 in which the further relative adjustments are made by changing current to the lasing cavity.
